(19) United States
(12) Patent Application Publication
(10) Pub. No.: US 2004/0148914 A1
(43) Pub. Date: Aug. 5, 2004

(54) Filter assembly for vacuum cleaner

(75) Inventors: Jong-Gook Lim, Gwangju-City (KR); Keon-Soo Choi, Gwangju-City (KR)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 10/645,152

(22) Filed: Aug. 21, 2003

(30) Foreign Application Priority Data
Dec. 31, 2002 (KR) 10-2002-0087915

(51) Int. Cl. B01D 46/00

(52) U.S. Cl. 55/429; 55/467

(57) ABSTRACT

Disclosed is a filter assembly for a vacuum cleaner, comprising a dust container having a desired-sized storing space and an upper opening; an inclined guide provided at an upper and outer circumferential surface of the dust container; a cover having a through-hole for sucking external air and disposed to cover the upper opening of the dust container; a fixing lever disposed at an outside of a rim of the cover so as to be slid and having a protrusion protruded toward an inner side of the cover, the protrusion being slid while contacted with the inclined guide, whereby the cover being closely contacted with the dust container; and a filter removably disposed at a filter mounting portion formed by opening a portion of a wall of the dust container. Therefore, it is facile that the cover 120 is closely contacted with the dust container using the inclined guide provided at the dust container and the fixing lever disposed at the cover so as to be contacted with the inclined guide and slid.

### BACKGROUND

1. Field of the Invention

The present invention relates to a vacuum cleaner, and more particularly, to a filter assembly for a vacuum cleaner, which is washable and reusable.

2. Description of the Related Art

Generally, a vacuum cleaner is to suck and remove dust or foreign substance on a cleaning surface into a dust chamber using suction force generated by driving of a vacuum motor disposed in a main body of the vacuum cleaner. In the dust chamber, there is provided a dust bag for collecting the dust or foreign substance.

If the suction force is generated by the driving of the vacuum motor, external air containing the dust or foreign substance on the cleaning surface is sucked in the dust bag. The sucked dust or foreign substance is stacked in the dust bag, and after the purified air is exhausted from the dust bag, the air is discharged to the outside of the main body of the vacuum cleaner. When the dust bag is filled with the sucked dust or foreign substance and thus the suction force of the vacuum cleaner is lowered, the dust bag is separated from the dust chamber and then disposed.

Since the use of the disposable dust bag causes an increase of a maintenance cost of the vacuum cleaner, recently, there has been developed a permanent filter that is washable and reusable. FIG. 1 shows a filter and a vacuum cleaner using the same disclosed in Korean Patent Application No. 10-2002-0068103 filed on Nov. 5, 2002 by the same applicant, as an example of the filter that is semi-permanently usable.

As shown in FIG. 1, a filter 20 for the vacuum cleaner comprises a cylindrical filter body 21 having a desired-sized storing space therein, a filter member 22 provided around the filter body 21 and a cover 23 for opening and closing an opening 21a formed at an upper portion of the filter body 21. The cover 23 is formed with a handle 24. Furthermore, an outer threaded portion 21b is formed at an upper external surface of the filter body 21, and an inner threaded portion corresponding to the outer threaded portion 21b is formed at an inner surface around the cover 23.

The filter 20 is disposed at a dust chamber 10a of a main body 10 of the vacuum cleaner with the cover coupled to the filter body 21. At this time, a through-hole 23a formed at an upper side of the cover 23 is communicated with an inlet hole 10b of the main body 10 of the vacuum cleaner. Therefore, the external air sucked through the inlet hole 10b is introduced through the through-hole 23a into the filter body 21. The dust or foreign substance contained in the sucked air is stacked in the filter body 21, and the purified air is passed through the filter member 22 formed of a porous material so as to come out of the filter body 21 and then exhausted to the outside of the main body 10 of the vacuum cleaner.

However, in order for the cover 23 to hermetically seal the upper opening 21a of the filter body 21, the filter 20 has to have a long contact length between the inner threaded portion of the cover 23 and the outer threaded portion 21b of the filter body 21. Therefore, when a user couples the cover 23 to the filter body 21 or separates the cover 23 from the filter body 21, it is inconvenient that the user has to turn the cover 23 many times.

Further, since the dust or foreign substance introduced into the filter body 21 is attached to a deep portion of the filter member 22 provided around the entire filter body 21, it is difficult to separate the dust or foreign substance from the filter body 21 including the filter member 22.

### SUMMARY

Therefore, it is an object of the present invention to provide a filter assembly for a vacuum cleaner, in which a cover is easily mounted to a filter assembly, and which can remove dust or foreign substance effectively.

To achieve an object of the present invention, there is provided a filter assembly for a vacuum cleaner, comprising a dust container having a desired-sized storing space and an upper opening; an inclined guide provided at an upper and outer circumferential surface of the dust container; a cover having a through-hole for sucking external air and disposed to cover the upper opening of the dust container; a fixing lever disposed at an outside of a rim of the cover so as to be slid and having a protrusion protruded toward an inner side of the cover, the protrusion being slid while contacted with the inclined guide, whereby the cover being closely contacted with the dust container; and a filter removably disposed at a filter mounting portion formed by opening a portion of a wall of the dust container.

Preferably, at a side of the inclined guide, there is provided a separation preventing jaw for preventing the protrusion of the fixing lever from being slid.

Further, at an inner surface of the cover, there is provided a shielding rib for reducing a flow rate of the sucked air discharged through the filter.

Preferably, on a bottom surface of the dust container, there is formed a barrier for restricting a flow of the foreign substance introduced into the dust container toward the filter.

The filter assembly according to the present invention further comprises a filter fixing member provided with a receiving portion for receiving the filter and disposed to be closely contacted with the opening; and a grill member fitted to the receiving portion, for preventing the filter inserted into the receiving portion from being separated. Preferably, at a side of the filter fixing member, there is provided a hook disposed to be coupled to a groove portion formed at a side of the filter mounting portion.

Further, it is preferred that a sealing member is disposed between the cover and the dust container.

Preferably, at the rim of the cover, there is provided guide means for guiding a movement of the fixing lever. The guide means comprises a lever guide disposed at an inner surface of the rim of the cover and a guide rail provided at the lever guide so as to be inserted into a guide groove formed at the fixing lever.

### BRIEF DESCRIPTION OF THE DRAWINGS

The above objects and other advantages of the present invention will become more apparent by describing in detail preferred embodiments thereof with reference to the attached drawings in which:

FIG. 1 is a perspective view of a conventional filter and a vacuum cleaner using the same;

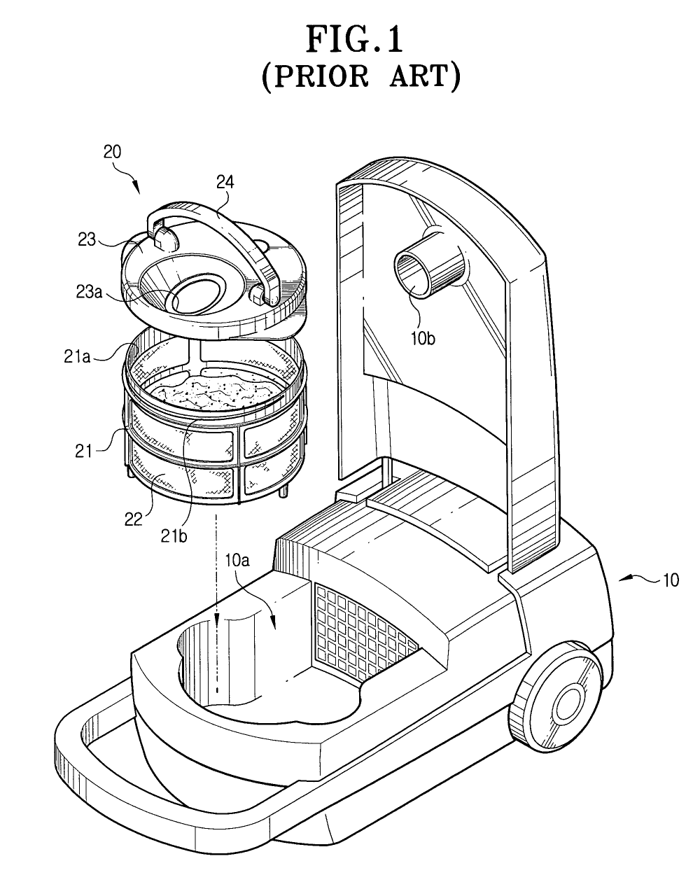

FIG. 2 is an exploded perspective view of a construction of a filter assembly for vacuum cleaner according to a preferred embodiment of the present invention;

FIG. 3 is a view showing an assembled status of the filter assembly for vacuum cleaner of FIG. 2;

FIGS. 4A and 4B are partial views of FIG. 3, showing an operation of a main part of the filter assembly for vacuum cleaner; and

FIG. 5 is a cross-sectional view of FIG. 3, showing the operation of the filter assembly for vacuum cleaner.

### DETAILED DESCRIPTION OF THE PREFERRED EMBODIMENTS

Now, a filter assembly for a vacuum cleaner according to a preferred embodiment of the present invention will be described in detail with reference to the annexed drawings.

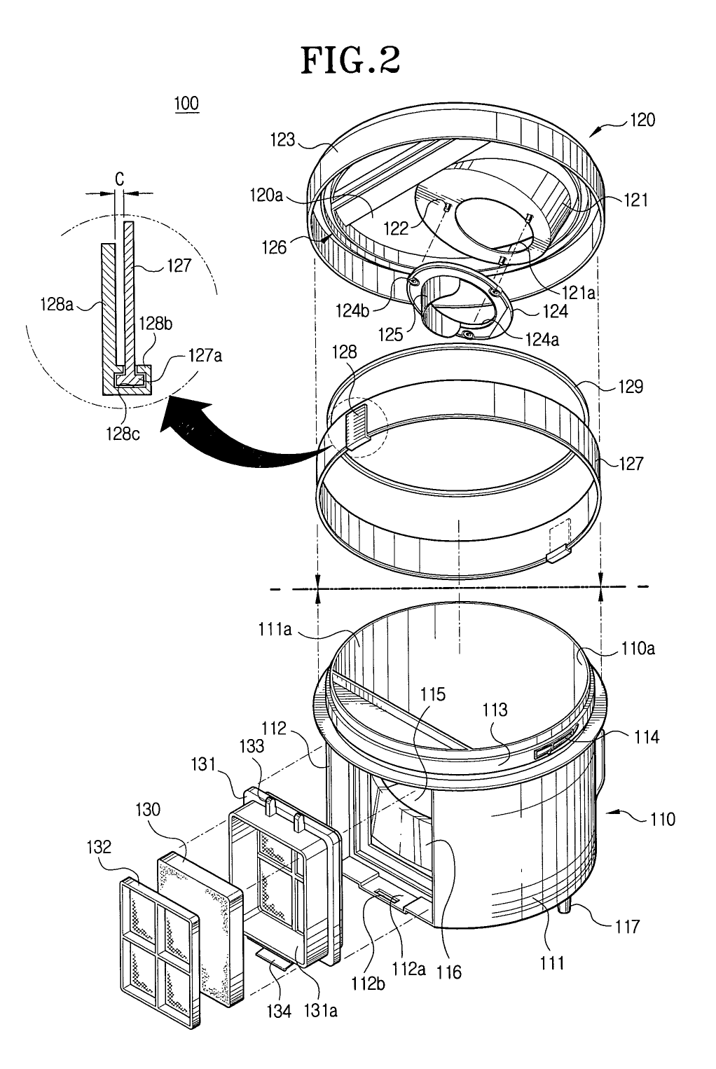

As shown in FIG. 2, a filter assembly 100 for vacuum cleaner comprises a dust container 110, a cover 120 and a filter 130.

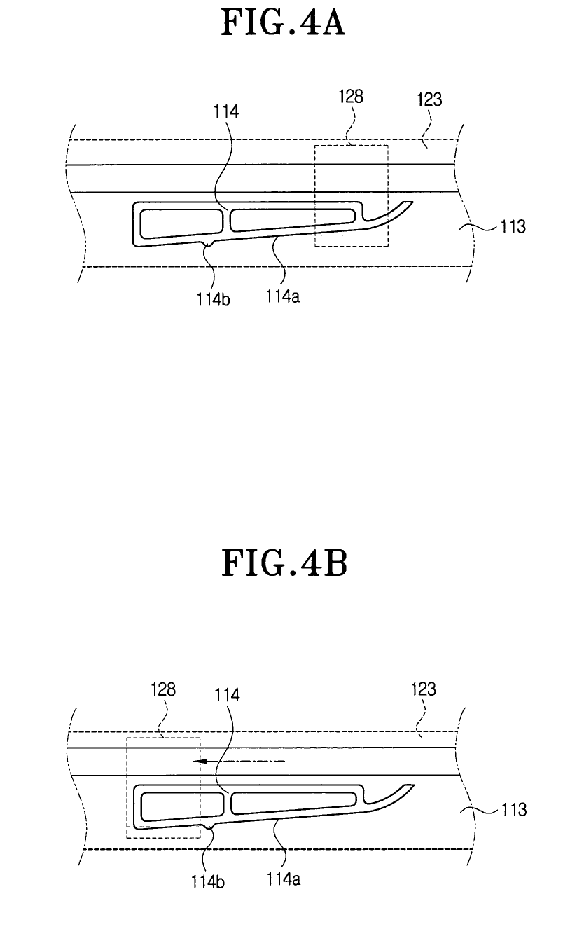

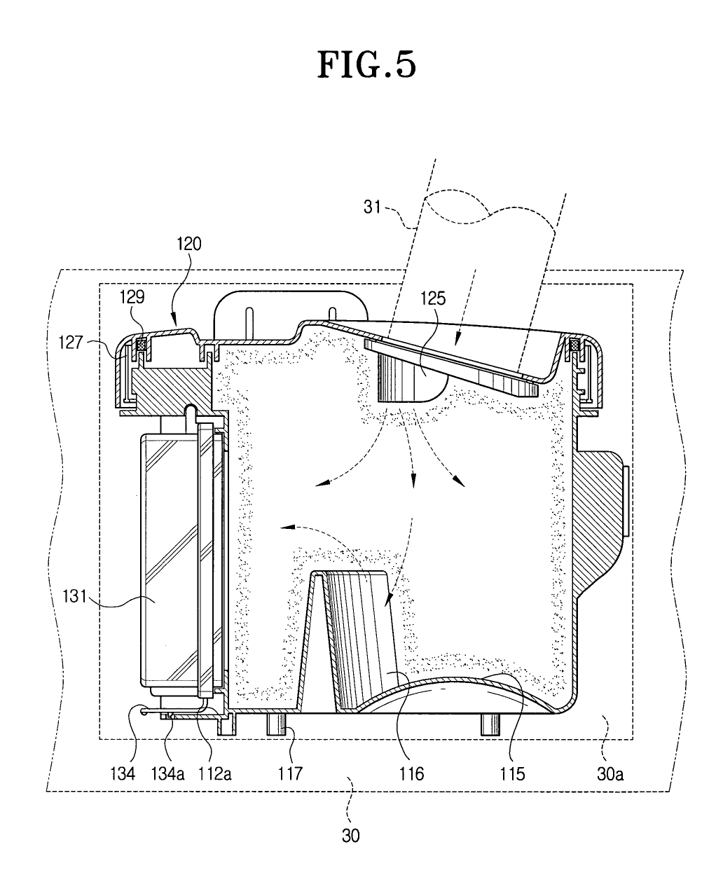

The dust container 110 has a cylindrical shape with an open upper portion, and a filter mounting portion 112 formed by opening a part of a wall surface 111 of the dust container 110. At a lower surface of the filter mounting portion 112, there is provided a groove portion 112a in which a fixing slot 112b is formed, and at an upper surface thereof, there is provided a coupling slot (not shown). Further, a pair of inclined guides 114 is symmetrically provided at an upper circumferential portion 113 of the dust container 110. Each of the inclined guides 114 has an inclined surface 114a (referring to FIG. 4A) that is inclined at a desired angle. On the inclined surface 114a, there is provided a separation preventing jaw 114b. A barrier 116 is provided on a bottom surface 115 of the dust container 110 so as to prevent the dust or foreign substance collected in the dust container 110 from being sucked toward the filter mounting portion 112 by the suction force when the vacuum cleaner is driven. The barrier 116 has an arc shape crossing between an inner wall 111a of the dust container 110 and other opposite inner wall 111a. Furthermore, a plurality of legs are provided on a lower surface of the dust container 110, so that the dust container 110 is apart from a bottom surface of a dust chamber 30a (referring to FIG. 5) at a desired distance when the dust container 110 is mounted in the dust chamber 30a.

The cover 120 is to open or close the upper opening 110a of the dust container 110, and has a depressed portion 121 that a portion of the cover 120 is caved toward an inner surface 120a. The depressed portion 121 is formed to be inclined toward the filter mounting portion 112 of the dust container 110. A through-hole 121a for sucking the external air is formed at a bottom surface of the depressed portion 121.

On the inner surface 120a of the cover 120, there is disposed a rib coupling member 124 having a communicating hole 124a communicated with the through-hole 121a. An arc-shaped shielding rib 125 is provided around the communicating hole 124a of the rib coupling member 124. The shielding rib 125 is to reduce a flow rate of the air sucked through the through-hole 121a, and extended downward so as to have a desired height. The rib coupling member 124 has a plurality of inserting holes 124b. The inserting holes 124b are inserted onto a plurality of fixing protrusions 122 formed on the inner surface 120a of the cover 120, whereby the rib coupling member 124 is fixed to the inner surface 120a of the cover 120.

In addition, around the inner surface 120a of the cover 120, there is formed an inserting groove 126 along an inner circumferential surface of a rim 123. An annular lever guide 127 is disposed at the inserting groove 126. The lever guide 127 may be fixed to the cover 120 using a coupling means such as an adhesive or a bolt. A pair of fixing levers 128 is symmetrically provided around the lever guide 127 so as to be corresponding to the inclined guides 114 of the dust container 110. The fixing lever 128 is provided with a button 128a for handling of a user and a protruded portion 128b contacted with the inclined guide 114 to be slid. A guide groove 128c is formed between the button 128a and the protruded portion 128b. The fixing lever 128 is disposed so that the guide groove 128c thereof is inserted onto a guide rail 127a formed at a lower end of the lever guide 127. Herein, between the button 128a and an outer surface of the lever guide, there is formed a clearance (c). The lever guide 127 is disposed at the inner side of the cover 120 so that the rim 123 of the cover 120 is inserted into the clearance (c). Therefore, the button 128b of the fixing lever 128 is positioned at an outside portion of the rim 123 of the cover 120, and the protruded portion 128b of the fixing lever 128 is positioned at an inside portion of the cover 120.

Moreover, at the inner surface 120a of the cover 120, there is provided a sealing member 129 for sealing between the dust container 110 and the cover 120.

The filter 130 is to filter the dust or foreign substance sucked in the dust container 110 together with the sucked air. Preferably, a HEPA filter is used as the filter 130. The filter 130 constitutes an assembly together with a filter fixing member 131 and a grill member 132, and is detachably disposed at the filter mounting portion 112. The filter fixing member 131 is provided with a receiving portion 131a for receiving the filter 130. At an upper portion of the filter fixing member 131, there is formed a coupling protrusion 133 corresponding to the coupling slot of the filter mounting portion 112. And at a lower portion of the filter fixing member 131, there is formed a hook having a protrusion 134A (FIG. 5) inserted into the fixing slot 112b of the filter mounting portion 112. One end of the hook 134 is fixedly attached to the lower portion of the filter fixing member 131, and the other end of the hook 134 is bent from the one end and then horizontally extended so as to be movable upward and downward at a desired distance. The grill member 132 is inserted into the receiving portion 131a of the filter fixing member 131, while the filter 130 is inserted into the receiving portion 131a, thereby preventing the filter 130 from being separated from the receiving portion 131a.

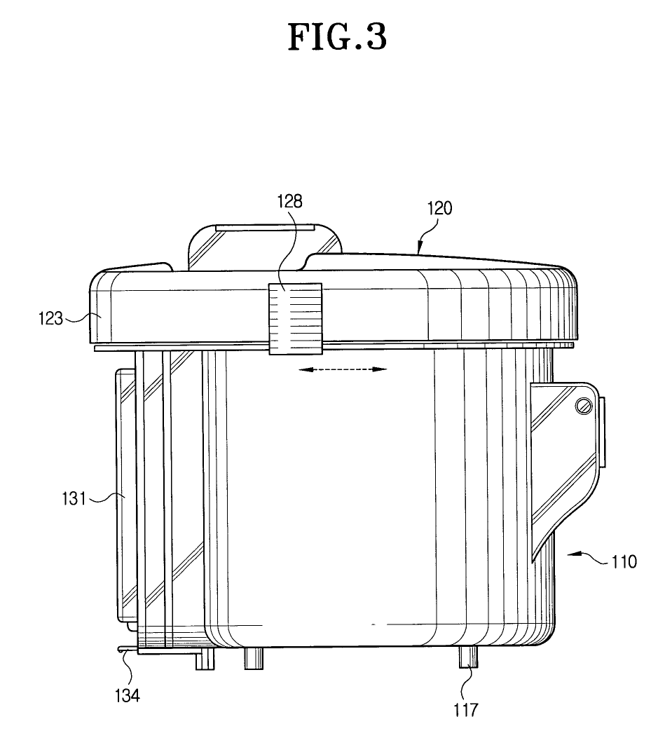

Hereinafter, an operation of the filter assembly 100 for the vacuum cleaner according to a preferred embodiment of the present invention will be described with reference to FIG. 3 to FIG. 5.

After the cover 120 is disposed to cover the upper opening 110a of the dust container 110, if the button 128a (FIG. 2) of the fixing lever 128 is moved in an arrow direction of FIG. 3 at an angle of about 30°, the protrusion 128b (FIG. 2) of the fixing lever 128 is moved while being contacted with the inclined surface 114a of the inclined guide 114. At this time, the protrusion 128b of the fixing lever 128 is diverted from a released state of FIG. 4A to a coupled state of FIG. 4B. The cover 120 is depressed toward the dust container 110 and then closely contacted with the dust container 110. Then, the sealing member 129 of the cover 120 is deformed by the contacting with an upper end of the dust container 110 so as to hermetically seal between the cover 120 and the dust container 110.

In such status that the cover 120 is hermetically coupled to the dust container 110, the filter assembly 100 is disposed in the dust chamber 30a so that the through-hole 121a of the cover 120 is connected with an inlet pipe 31 of the vacuum cleaner. When an suction motor of the vacuum cleaner is operated, the external air sucked through the inlet pipe 31 is sucked through the through-hole 121a into the dust container 110. At this time, the external air sucked through the through-hole 121a is collided against the shielding rib 125. A flowing direction of the air is turned toward the bottom surface 115 of the dust container 110, and thus the flow rate is reduced. Further, a part of the dust or foreign substance contained in the external air is fallen down on the bottom surface 115 of the dust container 110. The external air introduced toward the bottom surface 115 of the dust container 110 is collided against the barrier 116 in the dust container 110, and then sucked toward the filter 130. In this situation, the foreign substance fallen down on the bottom surface 115 of the dust container 110, or the foreign substance passing through the through-hole 121a together with external air and directly collided against the barrier 116 is blocked by the barrier 116 and thus cannot be facilely sucked toward the filter 130. Therefore, an amount of the dust or foreign substance attached to the filter 130 is reduced. The purified air in which the dust or foreign substance is separated while passing through the filter 130 is exhausted to the outside of the main body 30 of the vacuum cleaner.

Meanwhile, if a large amount of the dust or foreign substance is attached to the filter 130 by a cleaning operation for a long time and thus the suction force of the vacuum cleaner is lowered, the filter assembly 100 is drawn from the dust chamber, and the fixing lever 128 is moved to the released status so that the cover 120 is separated from the dust container 110. Furthermore, after the hook 134 of the filter fixing member 131 is lifted upward so that the protrusion 134A of the hook 134 is separated from the fixing slot 112b, the filter fixing member 131 in which the filter is received is separated from the dust container 110. Then, the dust or foreign substance collected in the dust container 110 is shaken off and removed, and the filter 130 is separated from the filter fixing member 131, so that the dust or foreign substance attached to the surface of the filter 130 is removed.

According to the present invention, as described above, it is facile that the cover 120 is closely contacted with the dust container 110 using the inclined guide 114 provided at the dust container 110 and the fixing lever 128 disposed at the cover 120 so as to be contacted with the inclined guide 114 and slid.

Further, according to the present invention, since the shielding rib 125 provided at the cover 120 and the barrier 116 formed on the bottom surface of the dust container 110 changes the flowing direction of the air so that the dust or foreign substance sucked into the dust container 110 together with the air cannot be directly flowed toward the filter, the amount of dust or foreign substance attached to the filter 130 is reduced. And it is also prevented that the dust or foreign substance is facilely sucked in the deep portion of the filter 130. Therefore, a cleaning period of the filter 130 and a life span of the filter 130 can be extended.

Furthermore, according to the present invention, since the filter 130 can be easily separated from the dust container 110, it is easy to shake the dust or foreign substance off the filter 130.

While the present invention has been described in detail, it should be understood that various changes, substitutions and alterations can be made hereto without departing from the spirit and scope of the invention as defined by the appended claims.

What is claimed is:

1. A filter assembly for a vacuum cleaner, comprising:
a dust container having a desired-sized storing space and an upper opening;
an inclined guide provided at an upper and outer circumferential surface of the dust container;
a cover having a through-hole for sucking external air and disposed to cover the upper opening of the dust container;
a fixing lever disposed at an outside of a rim of the cover so as to be slid and having a protrusion protruded toward an inner side of the cover, the protrusion being slid while contacted with the inclined guide, whereby the cover being closely contacted with the dust container; and
a filter removably disposed at a filter mounting portion formed by opening a portion of a wall of the dust container.

2. The assembly of claim 1, further comprising a separation preventing jaw provided at a side of the inclined guide, for preventing the protrusion of the fixing lever from being slid.

3. The assembly of claim 1, further comprising a shielding rib disposed at an inner surface of the cover, for reducing a flow rate of the sucked air discharged through the filter.

4. The assembly of claim 1, further comprising a barrier formed on a bottom surface of the dust container, for restricting a flow of the foreign substance introduced into the dust container toward the filter.

5. The assembly of claim 1, further comprising a filter fixing member provided with a receiving portion for receiving the filter and disposed to be closely contacted with the opening; and
a grill member fitted to the receiving portion, for preventing the filter inserted into the receiving portion from being separated.

6. The assembly of claim 5, further comprising a hook provided at a side of the filter fixing member so as to be coupled to a groove portion formed at a side of the filter mounting portion.

7. The assembly of claim 1, further comprising a sealing member disposed between the cover and the dust container.

8. The assembly of claim 1, further comprising guide means provided at the rim of the cover, for guiding a movement of the fixing lever.

9. The assembly of claim 8, wherein the guide means comprises a lever guide disposed at an inner surface of the rim of the cover and a guide rail provided at the lever guide so as to be inserted into a guide groove formed at the fixing lever.
